(19) United States
(12) Patent Application Publication
(10) Pub. No.: US 2024/0367217 A1
(43) Pub. Date: Nov. 7, 2024

(54) SUPPLY DEVICE, SUPPLY SYSTEM AND SYSTEM

(71) Applicant: TOX PRESSOTECHNIK GMBH & CO. KG, Weingarten (DE)

(72) Inventors: Michael BADENT, Weingarten (DE); Axel FISCHBACH, Ravensburg (DE); Frederik FREUDLING, Tettnang (DE); Patrick KALETTA, Friedrichshafen (DE)

(73) Assignee: TOX PRESSOTECHNIK GMBH & CO. KG, Weingarten (DE)

(21) Appl. No.: 18/741,874

(22) Filed: Jun. 13, 2024

Related U.S. Application Data
(63) Continuation of application No. PCT/EP2022/086617, filed on Dec. 19, 2022.

(30) Foreign Application Priority Data
Dec. 22, 2021 (DE) 10 2021 134 404.2

(51) Int. Cl. B21J 15/32; B25J 11/00

(52) U.S. Cl. CPC B21J 15/32; B25J 11/007

(57) ABSTRACT

A supply device designed as a separately positionable peripheral unit for supplying a processing device with elements, wherein a connection point is designed with a hollow transfer line that can be connected to the supply device such that the elements can be transferred in the hollow transfer line from the connection point to the processing device. The elements are transferred by means of a gas flow. The supply device has a gas flow generation device that transfers the elements from the connection point due to the gas flow provided by the gas flow generation device. The supply device is provided in an installation space, and the gas flow generation device takes in air from the environment of the supply device in the installation space of the supply device in order to provide the gas flow.

### CROSS REFERENCE TO RELATED APPLICATIONS

This application is a continuation of International Application No. PCT/EP2022/086617 filed Dec. 19, 2022, which designated the United States, and claims the benefit under 35 USC § 119 (a)-(d) of German Application No. 10 2021 134 404.2 filed Dec. 22, 2021, the entireties of which are incorporated herein by reference.

### FIELD OF THE INVENTION

The present invention relates to a supply device, supply system and system.

### BACKGROUND OF THE INVENTION

Devices or installations for supplying elements in the form of small parts, such as, for example, joining elements such as functional elements or connecting elements such as rivets, from a provided quantity of elements to a consumer of the elements are known. The elements are supplied, for example, to a processing apparatus or tool, wherein a compressed gas, for example, compressed air, is used as the transport means, or as an energy source, for transporting the elements in order to collect individual elements from a provided quantity of elements and for automatically supplying the elements.

Compressed air is used, for example, in pneumatic systems with a cylinder/piston unit, which utilize the compressed air as an energy source. The compressed air is provided in a centralized manner in industrial applications and supplied to the various consumers, for example. Compressors are used for this purpose.

It is disadvantageous in many compressed air applications that compressed air is inefficient as an energy source, and losses in the range of up to 90 percent or more are incurred. Losses are derived as, for example, compression losses, leakage losses, network losses or flow losses such as line network pressure losses.

### SUMMARY OF THE INVENTION

It is an object of the present invention to provide a supply device which avoids the disadvantages discussed, or in which the latter are minimized.

The present invention relates to a supply device for elements, wherein the elements are able to be moved to a connection point of the supply device, wherein the supply device is designed as a separately positionable peripheral unit for supplying a processing apparatus with elements, wherein the elements are able to be ejected from the supply device by way of the connection point, and wherein the connection point is configured to connect to a hollow transport line that is connectable to the supply device in such a way that in the connected state of the transport line, the elements are able to be transported in the hollow transport line from the connection point to the processing apparatus spaced apart from the supply device, wherein the elements are able to be transported by means of a gas flow.

The supply device has a gas flow generation installation which provides the gas flow in such a manner that, by virtue of the gas flow, the elements are able to be transported from the connection point by virtue of the gas flow provided by the gas flow generation installation, wherein the supply device is present in an installation space, wherein the gas flow generation installation is configured to induct air from the environment of the supply device in the installation space of the supply device in order to provide the gas flow.

For example, the connection point is configured for an, in particular, gas-tight connection of a line portion of the supply device to a hollow transport line connectable to the supply device. For example, the line portion and the transport line are integrally connected to one another at the connection point, for example, formed by a uniform hollow hose.

For example, the supply device has a storage container for receiving a plurality of elements.

For example, the elements are able to be transported from an element transfer point through the line portion to the connection point by way of the gas flow provided by the gas flow generation installation. For example, the elements are able to be transported out of the line portion, for example, into the transport line and onward within the transport line, by way of the gas flow provided by the gas flow generation installation.

The present invention proceeds from a supply device having a storage container for receiving a plurality of elements, wherein the supply device has a hollow line portion through which the elements are able to be moved from an element transfer point, at which the elements are able to be introduced into the line portion, to the connection point of the supply device, wherein the supply device is designed as a separately positionable peripheral unit for supplying a processing apparatus with elements, wherein the elements that are movable in the line portion are able to be ejected from the supply device by way of the connection point, and wherein the connection point is configured for an, in particular, gas-tight connection of the line portion to a hollow transport line connectable to the supply device in such a way that, in the connected state of the line portion and of the transport line, the elements are able to be transported in the hollow transport line from the connection point to the processing apparatus spaced apart from the supply device, wherein the elements are able to be transported in the line portion up to the connection point by means of a gas flow. The elements are moved by virtue of the gas flow prevalent in the line portion, wherein in the case of a transport line connected to the line portion, the elements are able to be moved onward from the connection point into the transport line, making their way in the transport line to the processing apparatus. Accordingly, in the case of a connected transport line, the gas flow continues from the line portion onward into the transport line, for example. The gas flow provides the driving force for transporting the elements in a transport direction of the elements in the line portion and in the transport line. In particular, the onward transport within the transport line takes place by virtue of the gas flow provided by the supply device. The gas flow in the line portion continues from the line portion, or out of the line portion, into the transport line and along the entire length of the transport line, in particular, up to the processing apparatus.

In the supply device, the elements are entrained by virtue of the gas flow at the element transfer point and in the line portion moved onward in a conveying direction within and along the line portion by the gas flow. By way of the kinetic energy of the respective element at the connection point, the elements continuously move onward within and along the transport line up to the processing apparatus.

For example, the supply device has a housing which surrounds an interior of the supply device. The interior preferably has a side or point which is connected so as to be open to the ambient atmosphere, or the ambient air, in an installation space in which the supply device is present. The housing has, for example, a base, a rear wall and vertical lateral walls.

The storage container for receiving a plurality of elements, for example, a maximum of several hundred individual elements, is disposed in the interior of the supply device. The elements kept ready in the storage container are randomly oriented, for example, e.g. present in the storage container as bulk goods. The storage container, or a receiving capacity of the storage container, for the elements is connected to a sorting bin by way of a hollow line-type intermediate piece, for example. The intermediate piece serves, for example, to allow an individual element emanating from the receiving capacity to pass through, and to guide the latter onward into the sorting bin. In the sorting bin, the elements are individually positioned in the correct orientation and transferred to a buffer line adjoining the sorting bin. In the buffer line, the elements are in each case offered up automatically in the same orientation behind one another in a row, for example. The elements make their way from the buffer line onward to a singularization installation for the elements. A respective frontmost element of the row makes its way from the singularization installation to the element transfer point. The respective element makes its way from the element transfer point into the line portion. This transfer is performed with the aid of the gas flow, for example. The transfer, or the transfer movement, of the elements is performed with the aid of gravity, for example. The gas flow is aligned in such a manner that the respective element is entrained into the line portion and is able to be transported along in the latter in the direction of, or up to, the connection point and beyond. The hollow line portion is, for example, a flexible hollow hose, or a hollow fixed line, for example.

For example, the supply device is designed in such a way that different types of elements are able to be processed or provided by the supply device and able to be transported by the gas flow. For example, connecting elements or joining elements such as screws and rivets, punch rivets, and/or functional elements such as stamping elements, punching elements, pressing elements, clinch-riveting elements, press-fit bolts and/or press-fit nuts are considered as elements.

The line portion extends, for example, from the element transfer point to the connection point, for example. The line portion and the transport line are often integral, for example, a hollow hose.

Alternatively, the connection point is formed by an open end of the line portion, for example. The connection point comprises, for example, an opening of the supply device through which compressed air flows during operation. However, it is advantageous, for example, for the line portion and the transport line to be integrally formed as a supply hose, for example. In this instance, the connection point is not visually recognizable as such. In this instance, the connection point is a point formed in the region of a line cross section. The cross section is in this instance an imaginary separation point between one end of the line portion and an end of the transport line that continuously adjoins the latter. For example, the connection point could be formed by severing the integral supply hose at the respective point of the cross section of the supply hose.

It is explained further below that a supply system according to the present invention comprises conjointly the supply device and the transport line.

It is not precluded that the element transfer point and the connection point are directly adjacent.

The core concept of the present invention lies in that the supply device has a gas flow generation installation which provides the gas flow in the line portion in such a manner that the elements are able to be moved from the element transfer point through the line portion to the connection point by virtue of the gas flow, wherein the elements by way of the gas flow provided by the gas flow generation installation are able to be transported from the connection point out of the line portion, wherein the supply device is present in an installation space, wherein the gas flow generation installation is configured to induct air from the environment of the supply device in the installation space of the supply device in order to provide the gas flow. The air is inducted from the environment of the supply device, in particular, from the immediate environment or the vicinity of the supply device, for example. The inducted air is, in particular, air from an air volume that surrounds the supply device. In the case of an operating gas flow generation installation, the inducted air is compressed and/or accelerated by the latter. The gas flow generation installation is likewise referred to as a gas compression unit. The compressed air provided by the latter flows onward to the element transfer point and onward into the transport line if the latter is connected.

In the connected state of the line portion and transport line, for example, in the case of a transport line connected by way of one end to the line portion, the elements are able to be transported in the transport line out of the line portion and onward, in particular, up to the processing apparatus, by way of the gas flow, or compressed air, provided by the gas flow generation installation, wherein the other end of the transport line is connected to the processing apparatus.

An advantageous decentralized compressed air supply for conveying the elements is provided by the proposed supply device. The disadvantages that would otherwise occur in the use of a centralized compressed air system for providing a gas flow in the line portion can be avoided, in particular.

As a result of the decentralized gas flow generation installation of the supply device, a raft of incurred losses are reduced in comparison to a centralized compressed air supply.

A gas flow generation installation is understood to mean, in particular, an installation which generates the gas flow from gas, for example air, for example, ambient air at a usual air pressure in the pressure range of typically one bar. The gas, or the air, is inducted by the gas flow generation installation directly from the close environment of the supply device, or in the vicinity of the supply device. In particular, no compressed air provided by a compressed air source not associated with the supply device is used. The air is inducted by the gas flow generation installation at an ambient pressure level of the air, and the gas flow is generated at a pressure level that is elevated in comparison to the ambient pressure. A gas flow generation installation is not understood to mean, for example, an installation such as, for example, an air regulator installation for reducing the pressure of compressed air previously generated at an elevated pressure in comparison to the atmosphere, which air regulator installation reduces down a compressed gas, or compressed air, at an elevated pressure to a lower pressure level. Instead, the gas flow generation installation serves to increase the pressure of, for example, air from the naturally present atmospheric ambient air in the installation space of the supply device, for example, in order to compress and/or accelerate the air by the gas flow generation installation.

For example, the gas flow generation installation is associated with exactly one supply device. For example, the gas flow generation installation is, for example, exactly one gas flow generation installation configured for generating the gas flow for an associated supply device. Exactly one supply device is preferably supplied with compressed air, or with the gas flow, from exactly one gas flow generation installation.

In principle, the gas flow generation installation can comprise exactly one machine such as, for example, exactly one compressor. Alternatively, the gas flow generation installation can have exactly two or exactly three, or more than three, compressors which in each case individually provide the gas flow from inducted ambient air. The two, three or more than three machines of the gas flow generation installation can also generate in each case one gas flow, and the individual gas flows, having in each case one volumetric gas flow, for example, can then be combined in order to provide the gas flow.

Compressed air applications have fundamental advantages in comparison to other energy sources. When conveying, for example, singularized elements by way of hollow lines such as hoses and the like by compressed air, the use of compressed air as a conveying medium has advantages. For example, the conveyance of elements by compressed air is distinguished by a comparatively low tendency toward mutual jamming of elements among one another and/or on wall portions of the line. Moreover, for example, abrasive wear and dirt is discharged from the line portion by the gas flow without additional complexity as an advantageous accompanying benefit. Finally, a malfunction on a, for example, central portion of the path along the compressed air conveying path, such as a leakage in the line portion, for example, or in the transport line, does not inevitably lead to an interruption in the conveyance of the elements, for example.

In the case of compressed air networks with a centralized generation of compressed air and onward transfer of compressed air, extensive lines and pipework are typically required, for example, which are associated with installations such as compressed air vessels, for example. Pressure losses occur in various way herein, the pressure losses being possible at a multiplicity of points. Besides compression losses, network-related pressure losses such as leakage losses also have a disadvantageous effect, for example.

For example, compression losses are pressure-dependent, wherein a universal and thus to some extent excessive pressure level is often prevalent for all connected different applications in known pressurized systems with a centralized compressed air supply. Associated pressure regulating, for example, for applications which require a correct conveying speed of the elements, leads to the losses mentioned.

Advantageously, the advantages of utilizing compressed air do not have to be dispensed with by the invention, because losses are minimized. The use of compressed air as a conveying medium when conveying, for example, singularized elements by way of hollow lines such as hoses and the like, has advantages in comparison to other conveying technologies which operate without compressed air. For example, a comparatively low tendency toward jamming and entraining of, for example, abrasive wear and dirt from the compressed air line.

According to the present invention, the gas flow, or the air flow, is generated directly in the supply device, or supply assembly, and not by any other external compressed air system extending to the latter, such as a centralized compressed air supply, for example. In particular, the supply device does not have any supply interface for a decentralized compressed air supply of the supply device, or can dispense with such a supply interface. Accordingly, the supply device advantageously does not have any compressed air connector, or any compressed air input, for example.

The gas flow generation installation is accommodated within a housing rack of the supply device, for example. Alternatively, the gas flow generation installation is present externally on an external side of the supply device. In particular, the gas flow generation installation is present within an interior of the supply device that is surrounded by a casing or a housing of the supply device. The interior of the supply device is open toward the environment at one point or on one side, for example, toward the surrounding space or toward the atmosphere. The supply device does not have any connector for the supply of compressed air from the outside, for example. Compressed air which is produced remote from the supply device is not required, or is dispensed with. The supply device does not require any compressed air which is connected to the supply device from the outside, for example, by way of a centralized compressed air supply, for example, by way of a supply line or compressed air line, and delivers compressed air to the supply device from the outside.

The gas flow generation installation is present in the region of the installation space, or in the installation space in which the supply device is installed or present, for example.

As an alternative to accommodating the gas flow generation installation within a housing of the supply device, the gas flow generation installation is accommodated remotely yet in the same installation space as the supply device. The gas flow generation installation is, for example, remote from the remaining sub-unit of the supply device and connected to the remaining sub-unit of the supply device by way of a connecting line or gas line for directing the gas flow.

Alternatively, the gas flow generation installation is connected by way of a gas line for directing the gas flow from the gas flow generation installation to the remaining sub-unit of the supply device. For example, the gas flow generation installation is remote from the remaining sub-unit of the supply device within a perimeter of up to 10 meters. The gas flow generation installation is remote from the remaining sub-unit of the supply device within a perimeter of up to, for example, 8 meters, within a perimeter of up to, for example, 6 meters, within a perimeter of up to, for example, 4 meters, within a perimeter of up to, for example, 2 meters.

In the process, air at ambient pressure level is inducted by the gas flow generation installation. The gas flow generation installation for this purpose has, for example, an induction unit for inducting a gas volume such as an ambient air volume. The gas flow generation installation has, for example, an axial compressor and/or a radial compressor.

A gas flow directed in the direction of the connection point is generated in the line portion by the gas flow which is generated on site, or at the supply device, and flows into the line portion, for example, by way of an air flow lock, for example, a valve assembly. The elements in the line portion are surrounded by a flow of the gas, or surrounded by the gas flow. The directed gas flow entrains the elements in the line portion and continues to form into the transport line.

The transport line which adjoins the supply device at the connection point is not part of the supply device.

The line portion and the transport line preferably have the same internal shape and/or the same internal diameter.

The line portion and the transport line have the same interior or cavity, for example.

The supply device forms, for example, a unit such as a peripheral unit which is provided with rollers on the lower side and is movable, for example. The supply device is a peripheral unit which is easy to handle so that the supply device is able to be moved or rolled on a solid and flat ground by a person, in order to be positioned in the region of use or operation. The supply device is, for example, a separately positionable peripheral unit so that a spatial position of the supply device relative to the processing apparatus is able to be variably adjusted. The peripheral unit is, in particular, able to be installed independently of the position of the processing apparatus. Only a sufficient length of the transport line has to be provided.

For example, the gas flow generation installation is configured to provide a gas flow at a low-pressure level with an absolute gas pressure between 1.03 bar and 1.50 bar at an outlet side of the gas flow generation installation. In this way, energy losses owing to higher pressures in the provided gas are minimized.

Increasing the gas pressure by a thermal machine for compressible media such as gas or air is described by the characteristic n of the pressure ratio. The characteristic n describes the ratio of the gas pressure on a pressure-side of the gas flow generation installation to the gas pressure on an induction side of the gas flow generation installation.

For example, the gas inducted by the gas flow generation installation has a mean ambient pressure. For example, the gas inducted by the gas flow generation installation has an output pressure. The output pressure of the gas is prevalent on the input side, such as the induction side, of the gas flow generation installation.

For example, the accelerated gas on the pressure-side has an output pressure. The output pressure is prevalent on the output side of the gas flow generation installation.

For example, the gas flow generation installation is adapted to a shape and/or a size of the elements to be transported in such a manner that the elements in the transport line move at a speed between 3 meters per second, or 3 m/s, and 30 m/s. For example, the output pressure of the gas flow generated by the gas flow generation installation is adapted to a shape and/or size of the elements to be transported. For example, the output pressure of the gas flow generated by the gas flow generation installation is adapted to the type of elements and an inner cross section of the transport line. For example, the output pressure of the gas flow generated by the gas flow generation installation is adapted to a shape and/or size of the elements to be transported in such a manner that an element in the transport line moves at a speed between 3 meters per second, or 3 m/s, and 30 m/s. For example, an element of the transport line moves at a speed between 15 and 20 m/s.

For example, the gas flow generation installation such as, for example, a fan or a blower, operates with the characteristic n of the pressure ratio between 1.0 and 1.5.

For example, no higher pressure of the gas on the pressure-side, and thus in a system comprising the supply device, than is required for transporting the elements is generated by the gas flow generation installation. The elements herein are able to be transported by the gas flow generated by the gas flow generation installation. For example, no regulating of a comparatively high pressure emanating from a centralized pressure supply to a pressure which is actually used for the respective application takes place. An energy loss is avoided. For example, no reservoir for the gas provided on the pressure-side with a comparatively high pressure by the gas flow generation installation is required.

For example, the gas flow generation installation is configured to provide a pressure ratio n in a range from 1.0 to ≤4. For example, the gas flow generation installation is configured to provide a pressure ratio n in a range from 1.03 to ≤1.5.

For example, the gas flow generation installation is configured to provide a pressure ratio n in a range from 1.03 to ≤3.5, or a pressure ratio n in a range from 1.03 to ≤ 3.0, or a pressure ratio n in a range from 1.03 to ≤ 2.5, or a pressure ratio n in a range from 1.03 to ≤ 2.0, or a pressure ratio n in a range from 1.03 to ≤1.5.

For example, the gas flow generation installation comprises a fan or a ventilator.

For example, a fan in terms of its output achieves mean volumetric flows with a mean pressure ratio n.

For example, a ventilator in terms of its output achieves high volumetric flows with a low-pressure ratio n.

For example, the gas flow generation installation comprises exactly one fan. For example, the gas flow generation installation comprises a fan which provides a pressure ratio n between 1.1 and ≤4.

For example, the fan is of a radial construction. For example, the fan is of an axial construction. For example, the gas flow generation installation comprises a radial fan or an axial fan. For example, the gas flow generation installation is a fan. For example, the gas flow generation installation is a radial compressor such as, for example, a radial fan. For example, the gas flow generation installation is an axial compressor such as, for example, an axial fan.

For example, the fan is single-stage or multi-stage.

For example, the gas flow generation installation such as the fan has a filter unit such as, for example, a filter installation, for example, comprising a filter medium or a filter layer, on a suction-side of the fan.

For example, the fan for guiding the gas flow has a suction line on the suction-side and a pressure line on the pressure-side. On the suction-side and/or the pressure-side of the fan, the respective suction line or pressure line has a line cross section which corresponds to 0.5 times to 3 times the line cross section of the transport line from the supply device to the processing apparatus. For example, the suction line and the pressure line have a line cross section of at least 30 square millimeters (mm²). For example, the suction line and the pressure line have a line cross section of at least 50 square millimeters (mm²).

For example, the fan has a classic ventilator characteristic curve or a classic fan characteristic curve, in which the volumetric flow requires the largest proportion of energy.

For example, the fan has an electrical power input between 50 Watts (W) and 1500 Watts, for example, 500 Watts (W). For example, the power input is substantially self-regulating over the fan characteristic curve. Alternatively, the power input can be influenced indirectly, for example, by way of a tachometer, the values of the latter being able to be read and provided to a control unit, for example, for controlling a rotating speed of the fan.

For example, the fan occupies an installation space which is at least approximately cuboid or cubical and is in a range of 200 mm×200 mm×200 mm, for example.

For example, the gas flow generation installation comprises exactly one ventilator. For example, a ventilator is an externally driven turbo machine which conveys a gaseous medium by means of a rotating impeller.

For example, the gas flow generation installation comprises a ventilator which provides a pressure ratio Π between 1.0 and ≤1.1. For example, the gas flow generation installation is a ventilator. For example, the gas flow generation installation is an axial ventilator.

For example, the gas flow generation installation is a radial ventilator.

For example, a higher pressure ratio n is provided by the gas flow generation installation for comparatively small elements to be transported, for example, by means of a radial fan. Alternatively, a plurality of ventilators or a plurality of fans connected in series can be used. For example, two or more ventilators, or two or more fans, such as axial fans, which are connected in series can be used.

For example, a lower pressure ratio n is provided by the gas flow generation installation for comparatively large elements to be transported, for example, by means of an axial fan or a ventilator.

For example, the gas flow generation installation conveys a gas such as, for example air, from an induction side of the gas flow generation installation to a pressure-side of the gas flow generation installation. An induction pressure is prevalent on the induction side of the gas flow generation installation, for example, with a suction-side pressure of the gas on the induction side of approximately 1 bar.

Moreover, the gas such as, for example, air which is conveyed by the gas flow generation installation is accelerated from the induction side to the pressure-side of the gas flow generation installation.

A normal air pressure has a normal pressure, for example, a mean air pressure of 1013.25 mbar at sea level. The air pressure on site depends on the temperature of the gas and the altitude of the site, for example.

For example, an air pressure of 1013.25 mbar is utilized as a reference air pressure in the environment of the supply device, or of the gas flow generation installation, for calculating the pressure ratio n. For example, the air pressure of 1013.25 mbar is established as the induction pressure.

For example, the gas flow generation installation comprises a fan which generates an output volumetric flow up to 860 liters/minute (1/min).

For example, the gas flow generation installation comprises two, or more than two, ventilators which are connected in series. A desired output pressure level which is above a pressure-side level, or above an output pressure level, achievable by a single ventilator can thus be achieved by the plurality of ventilators, for example, of identical type or different types.

For example, the gas flow generation installation comprises two, or more than two fans, which are connected in series. A desired output pressure level which is above a pressure-side level, or above an output pressure level, achievable by a single fan can thus be achieved by the plurality of fans, for example, of identical type or different types.

For example, the gas flow generation installation, such as a ventilator or a fan, has an electric drive such as an electric motor which can be operated with a low voltage, for example, with an electrical voltage of 24 Volts or 48 Volts. For example, the electric motor is a brushless DC motor.

The gas flow generation installation advantageously comprises a gas compression unit for providing the gas flow. For example, the gas compression unit is an integral constituent part of the supply device. The gas compression unit is adjustable or variable in terms of its output data, for example. With the gas compression unit, gas such as air from the immediate environment of the supply device, or the gas compression unit, thus ambient air surrounding the supply device, can be inducted and compressed by the gas compression unit. The basic design or configuration of the compression unit is advantageously adaptable to the general requirements, or the present specification of the conveyance of elements. Frictional influences or frictional losses in the transport of the elements are to be taken into account in the process, for example. The induction and compression of the air is performed so as to be exactly adapted temporally and in terms of the characteristic values to the application and the site where the compressed air is utilized. This minimizes losses and is thus economically and/or ecologically advantageous.

The gas compression unit is, in particular, adapted to provide a variable gas flow over time. It is thus possible that the gas flow is utilized in a flexible manner. A consistent or continuously identical or non-variable gas flow is also possible. The pressure level provided by the gas flow can be provided variably, by adjusting the gas compression unit, and/or consistently.

It is moreover advantageous for the gas flow generation installation to comprise a gas compression unit according to the turbo-compressor principle for providing the gas flow. For example, the gas compression unit is a turbo-compressor, a turbo machine which is configured as a radial compressor or an axial compressor, for example. The turbo-compressor has a rotating compressor part which is mounted in a compressor housing. The turbo-compressor operates according to the reversed physical principle of a turbine.

For example, the gas flow generation installation comprises a gas compression unit for providing a gas flow generated at the pressure-side in the line portion. The gas compression unit operates according to, for example, the turbo-compressor principle, or based on the turbo-compressor principle. The elements are surrounded by a flow of the compressed air exiting from the gas flow generation installation at the pressure-side, and are entrained in the line portion as a result.

The gas flow generation installation advantageously comprises, for example, a gas compression unit for providing a gas flow which is generated at the suction-side in the line. The gas compression unit operates, for example, according to the turbo-compressor principle, or based on the turbo-compressor principle. The elements are surrounded by a flow of air which subsequently enters the gas flow generation installation at the suction-side, and are entrained in the line portion as a result.

According to an exemplary configuration, the gas flow generation installation comprises a gas compression unit having a radial compressor for providing the gas flow, wherein the gas compression unit operates according to the turbo-compressor principle. In this way, the gas flow is adaptable in a flexible manner.

It is furthermore proposed that the gas flow generation installation comprises, for example, a gas compression unit having an axial compressor for providing the gas flow, wherein the gas compression unit operates according to the turbo-compressor principle. In this way, the gas flow is adaptable in a flexible manner.

The gas flow generation installation advantageously comprises a gas compression unit having a multi-stage compressor, wherein the gas compression unit operates according to the turbo-compressor principle. In this way, a pressure level of the gas flow can be defined, for example, as a function of the number of stages of the compressor.

According to one exemplary modification, a superordinate control unit for controlling an output stage of the gas flow generation installation is present.

The control unit serves, for example, to control a definable or adaptable and/or adjustable output stage of the gas flow generation installation. For example, the compression of compressed air, the generation of compressed air and the air output provided therewith can be defined and/or varied by the control unit. The air output that can be provided is, in particular, adaptable to a real air requirement, for example, a respective momentarily required air requirement, for example, dynamically adaptable, by the control unit. The real air output is, in particular, programmable and/or dynamically adaptable to the real requirement based on sensor values detected by sensor mechanism of the supply device, for example. Detected sensor values relate, for example, to a speed of the conveyed elements in the line portion and/or the transport line. Based on the speed of the conveyed elements in the line portion and/or the transport line detected by sensors, it is possible to adapt the speed of the conveyed elements to a target value or nominal value of the speed of the transported elements stored in software, for example, by using the control unit.

According to an exemplary modification of the supply device, sensor mechanisms for detecting and providing sensor values and for adapting a gas flow demand for providing the gas flow are present. Sensor values pertaining to, for example, characteristics in terms of the elements and/or the gas flow can be detected by the sensor mechanism. Sensor values can be continuously or discontinuously detected and provided by the sensor mechanism. For example, sensor values for processing by the control unit can be provided by the sensor mechanism. For example, the sensor mechanism, or the provided sensor values, serve, in particular, to dynamically adapt the gas flow demand. For example, data which represent a speed of the elements during transport through the line portion and/or the transport line can be provided by the sensor mechanism. The sensor mechanisms are, for example, position sensors or position-detecting sensors, for example, having a defined spacing from the object to be measured. Other sensors which detect and transmit sensor data, for example, in terms of the gas flow and/or the moving elements in the line portion and/or the transport line, are also possible.

With the data that can be provided by the sensor mechanism of the control unit, it is also possible, for example, to control and/or adjust the speed of the elements to a target value of the speed of the elements during the movement through the line portion and/or the transport line.

The sensor mechanisms comprise, for example, sensor mechanisms for detecting a gas pressure, for example, and/or for detecting a gas volumetric flow of the gas flow generated by the gas flow generation installation, for example.

It is moreover advantageous for the supply device to be configured as a separate peripheral unit with a housing and an interior of the supply device that is surrounded by the housing. In this way, the supply device is able to be used flexibly for different applications. The peripheral unit is configured as a mobile unit in such a manner, for example, that a person can move the supply device manually in an installation space, for example, in particular, to a desired installation site within the installation space.

The peripheral unit has, for example, travelling means for moving the peripheral unit, or the supply device, so as to travel on rollers or wheels, for example.

The supply device has, for example, at least one further component, for example, a sorting bin adjacent to the storage container and/or next to the line portion, a buffer section, and/or a singularization installation. The singularization installation serves, for example, to singularize the elements from a series of elements offered up, for example, for example, a first or frontmost element from the series, prior to entering the line portion.

The supply device is configured, for example, so as to be adaptable in such a manner so as to offer up elements and supply the latter from the supply device to the processing apparatus, wherein the elements are joining elements such as screws, rivets, punch rivets, functional elements such as stamping elements, punching elements, pressing elements, clinch-riveting elements, press-fit bolts and/or press-fit nuts. In this way, the supply device is able to be used in many ways and in a flexible manner for different placing tasks. Tools such as pressing or stamping or clinching tools can be served, and corresponding matching elements supplied to the tool, by the supply device.

The elements are, for example, one-piece or integral elements.

For example, the line portion and the transport line are adapted so as to match the elements that are able to be transported therein by the gas flow, for example, adapted to the shape and/or the size of the elements.

Furthermore, the supply device has, for example, a filter unit for filtering the gas which serves to provide the gas flow. The filter unit is, for example, a gas filter unit such as a fine air filter and/or a coarse air filter. The filter unit is, in particular, provided at the suction-side of the gas flow generation installation. In this way, the gas, or the air inducted by the gas flow generation installation, is relieved of particles, for example. Fine particles such as, for example, dust particles can be removed almost completely, for example, up to a degree of 90%, from the inducted gas, or from the inducted air, by the filter unit. In this way, filtering, such as cleaning, of the inducted and compressed and/or accelerated air volume takes place prior to it entering the gas flow generation installation.

The present invention moreover relates to a supply system having a hollow transport line and a supply device, wherein a supply device according to one of the configurations as described above is provided. Accordingly, the system comprises a supply device as described above, and additionally the transport line. Different processing apparatuses can be served in this way. The transport line comprises, for example, a flexible holler supply hose or a rigid hollow line.

Supplying the elements in the transport line from the supply device to a processing apparatus takes place, for example, in each case in a discrete element unit when transporting the elements: for example, individually, or as a unit of exactly two, or exactly three, or more adjacent elements which are in contact with one another in a series of elements, for example.

Transporting takes place by way of the line portion and by way of the hollow transport line, wherein the transport line serves to transport the elements in a guided manner and bridges a region between the supply device and the processing apparatus.

Finally, the present invention extends to a system having a processing apparatus for processing elements, having a supply system as described above. The system is, for example, a technology system having a decentralized provision of compressed air and/or a decentralized supply of compressed air. The gas flow generation installation, for example, a compressed air supply for providing and transporting the elements, is integrated in the supply device, for example.

The processing apparatus is configured to process the elements supplied by the supply device. The processing apparatus is, for example, a tool for placing the elements on a workpiece, for example, in order to attach the elements to a workpiece. For example, the system additionally has a robot. For example, the processing apparatus is connected to a robot, or received on a movable robotic arm of the robot. The robot serves, in particular, to operate and move the processing apparatus in space, in order to attach the elements to a workpiece using the processing apparatus, for example.

The processing apparatus, which is configured as a rivet processing apparatus, for example, has a hydraulic-pneumatic or pneumatic-hydraulic drive, for example, and a C-bracket with two legs, for example. A ram unit is received on the one leg of the C-bracket, for example, and a die unit of the processing apparatus is received on the other leg, for example.

Alternatively, a robotic claw can have an element magazine, for example. Using a plurality of processing apparatuses, a technology system having exactly two, or more than two, processing apparatuses or supply devices is able to be provided, for example.

For example, a gas flow generation installation by way of which air is able to be inducted from the environment of the processing apparatus (3) is provided on the processing apparatus, in order to provide a gas flow, wherein providing at an outlet side of the gas flow generation installation a gas flow at a low-pressure level with an absolute gas pressure between 1.03 bar and 1.50 bar.

Alternatively, a processing apparatus for elements is proposed, wherein provided is a gas flow generation installation by way of which air is able to be inducted from the environment of the processing apparatus in order to provide a gas flow for transporting elements, wherein providing at an outlet side of the gas flow generation installation a gas flow at a lower-pressure level with an absolute gas pressure between 1.03 and 1.50 bar. For example, the processing apparatus has a storage container for a plurality of elements. Singularized elements from the storage container on the processing apparatus can be transported individually to a transfer point of the processing apparatus by way of the gas flow generation installation. An element is moved onward by, for example, a movable ram of the processing apparatus at the transfer point of the processing apparatus, and is processed on the latter, for example, pressed into a workpiece.

The processing apparatus having a gas flow generation installation can also be used as an alternative to a processing apparatus without a gas flow generation installation in the system described above.

### BRIEF DESCRIPTION OF THE DRAWINGS

Further features and advantages are explained in more detail by means of the exemplary embodiments schematically illustrated in the figures.

FIG. 1 shows a schematically illustrated system for attaching elements to workpieces, comprising a supply device, a processing apparatus, and a transport line;

FIG. 2 shows the assembly according to FIG. 1 without workpieces and without a robot;

FIG. 3 shows an upper fragment of the supply device from FIGS. 1 and 2 in a frontal view, without a device door on the front side;

FIG. 4 shows an alternative supply device in a perspective view, without a housing part on the front side;

FIG. 5 schematically shows an alternative system having a supply device, a transport line, and a processing apparatus with an indicated workpiece;

FIG. 6 schematically shows an alternative system to that of FIG. 5; and

FIG. 7 shows a processing apparatus having a gas flow generation installation.

### DETAILED DESCRIPTION OF THE INVENTION

The same reference signs are in some cases used for equivalent elements of different exemplary embodiments.

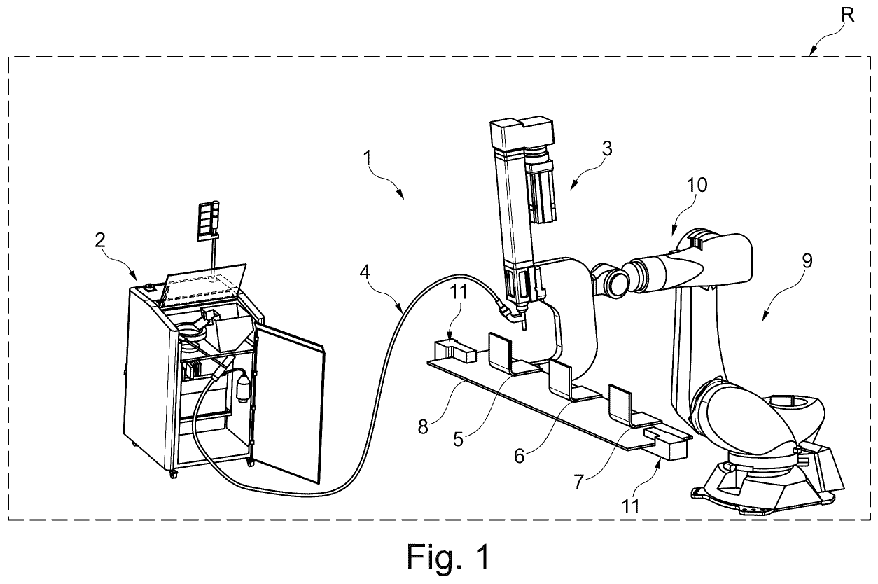

FIG. 1 shows a system 1 for processing elements (not illustrated in FIGS. 1 to 3) in a perspective view. The system 1 comprises a supply device 2, a processing apparatus 3, and a hollow transport line 4. The transport line 4 is designed as a hollow flexible supply hose, for example. The transport line 4 by way of one end 4b is connected to the processing apparatus 3 by way of the line connection 3a of the processing apparatus 3.

The system 1 serves to act on, or process, workpieces 5, 6, 7 and 8 which are fixedly present on a processing station 11. Acting on the workpieces 5 to 8 in order to attach an element to a join takes place using the processing apparatus 3 for processing the elements, or, for example, for placing an element on the join on the respective workpiece 5 to 8. For example, the angular workpieces 5 to 7 are in each case riveted to the workpiece 8 which is configured as a flat layer of sheet metal. The workpieces 5 to 7 are positioned so as to be uniformly spaced apart from one another on an upper side of the workpiece 8. According to FIG. 1, the processing apparatus 3 is present in the region of the workpiece 5.

The processing apparatus 3 is connected to a robot 9, or is received on a movable robotic arm 10 of the robot 9. The robot 9 serves to operate and move the processing apparatus 3 in space, in order to attach the elements to the workpieces 5 to 8, for example.

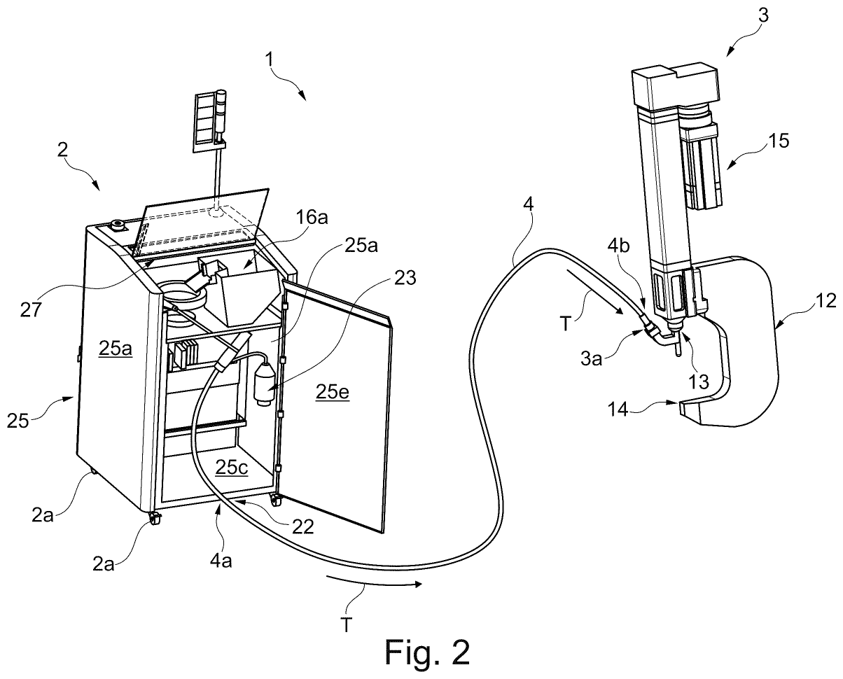

The processing apparatus 3, which is configured as a rivet processing apparatus, for example, has a hydraulic-pneumatic or pneumatic-hydraulic drive 15, for example, and a C-bracket 12 with two legs. A ram unit 13 is received on one leg of the C-bracket 12, and a die unit 14 of the processing apparatus 3 is received on the other leg (see FIG. 2).

The system 1 including the robot 9 and the processing station 11 having the workpieces 5 to 8 are positioned in an installation space R. The installation space R, which occupies part of a factory shed, for example, is schematically illustrated so as to be bordered by dashed lines in FIG. 1.

FIG. 2 shows the system 1 without the workpieces 5 to 8 and without the robot.

The supply device 2 and the processing apparatus 3 are connected to one another by way of the hollow transport line 4. The elements are transported within the, in particular, gas-tight transport line 4 by a gas flow in the transport direction T, from the supply device 2 to the processing apparatus 3. The elements arriving at the processing apparatus 3 are directed onward in corresponding line portions of the processing apparatus 3, and placed on the respective join of the workpieces 5 to 8 by the ram unit 13. For example, rivets such as punch rivets, clinch rivets, or functional elements, are placed on the workpieces 5 to 8 by the processing apparatus 3.

The supply device 2 is designed as a peripheral unit, which is separate from the processing apparatus 3, for example, having rollers 2a on the lower side for moving the processing apparatus 3 in a traveling manner on firm ground.

The supply device 2 has a storage container 16 having a receiving capacity 16a for offering up, or receiving, a plurality of elements (not illustrated). The storage container 16 is connected to a sorting bin 18 by way of a hollow line-type intermediate piece 17, so as to allow individual elements to pass through. The elements arriving from the intermediate piece 17 are individually positioned in the correct orientation in the sorting bin 18, and transferred to a buffer line 19 that adjoins the sorting bin 18. The elements are in each case offered up in the same orientation behind one another in one row in the buffer line 19. From the buffer line 19, the elements make their way onward and downward to a singularization installation 20 for the elements.

From the singularization installation 20, the elements make their way individually into a hollow line portion 21 of the supply device 2. The elements reach a connection point 22 of the supply device 2 through the line portion 21.

The elements are able to be ejected from the supply device 2 at the connection point 22. At the connection point 22, the line portion 21 is connected to one end 4a of the transport line 4 in a gas-tight manner, for example. In the exemplary embodiment shown, the line portion 21 and the transport line 4 are configured to be mutually integral, or integrally connected to one another. By way of example, the line portion 21 and the transport line 4 are formed by a contiguous piece as a supply hose.

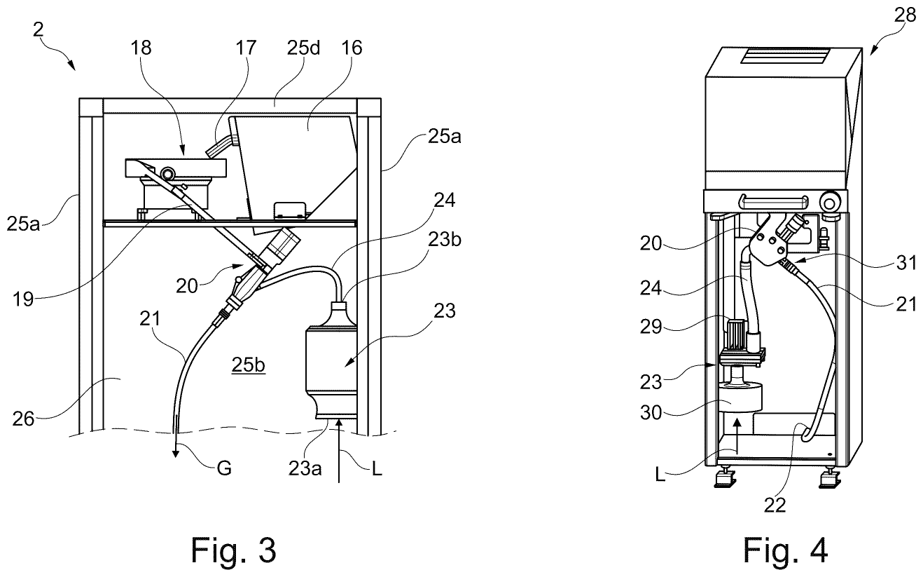

The elements are able to be transported in the line portion 21 and in the transport line 4 from the connection point 22 to the processing apparatus 3, which is spaced apart from the supply device 2, with the aid of, or by means of, a gas flow G. For example, the elements are individually entrained in the region of the singularization installation 20 by the gas flow G prevalent in the line portion 21 (see FIG. 3), and transported in the direction of the connection point 22. The gas flow continues in the transport line 4, so that the elements are moved from the line portion 21 into the transport line 4. The low-friction transport of the elements in the transport line 4 takes place up to an end 4b of the transport line 4 by virtue of the gas flow G in the transport line. The end 4b of the transport line 4 extends up to the line connection 3a on the processing apparatus 3, for example, in the region of the ram unit 13. The end 4b of the transport line 4 is connected to the line connection 3a on the ram unit 13, through which the elements make their way individually and in the correct position into a ram channel of the ram unit 13, for example, being blown into the ram channel with the aid of the gas flow G.

For providing the gas flow G in the line portion 21 and onward in the transport line 4, the supply device 2 has a gas flow generation installation 23. For example, the gas flow generation installation 23 is an axial fan. For example, the gas flow generation installation 23 is provided exclusively for the supply device 2, in order for the elements to be conveyed by means of the gas flow G. Atmospheric air L is inducted from the environment by way of a suction-side 23a of the gas flow generation installation 23, which is open toward the environment or atmosphere, and the air is compressed and/or accelerated in the gas flow generation installation 23. The gas flow generation installation 23 is, for example, able to be electrically operated by an integrated drive motor or electric motor. A pressure-side 23b of the gas flow generation installation 23 is connected to the singularization installation 20 by way of a connecting line 24 that conducts compressed air, for example. In the process, the compressed air-gas flow makes its way into the region of the line portion 21 which is connected to the singularization installation 20. The gas flow causes a suction force, or entrainment force, acting on a singularized element on a discharge side of the singularization installation 20. The incoming compressed air flows over into the line portion 21 and entrains an individual element, which is the frontmost in the singularization installation 20, or a singularized element, onward into the line portion 21, for example. When viewed toward the singularization installation 20, the singularization installation 20 singularizes the frontmost element from a series of elements that are lined up at the singularization installation 20 in the buffer line 19.

In the case of an active gas flow generation installation 23, the elements which are successively singularized by the singularization installation are able to be moved through the line portion 21 to the connection point 22 by the gas flow.

In the connected state of the line portion 21 and the transport line 4, the elements are able to be transported by the gas flow from the connection point 22 out of the line portion 21 and onward in the transport line 4 up to the processing apparatus 3.

The gas compressor unit 23 is configured to induct air L from the environment of the supply device 2 on the suction-side 23a of the gas compressor unit 23, in order to provide the gas flow.

The gas flow generation installation 23 is configured to induct air at an atmospheric pressure from the environment of the supply device 2, thus proportions of the air in the installation space R of the supply device 2, on the suction-side 23a of the gas compressor unit 23, in order to provide the gas flow. For example, the suction-side 23a is present within a housing 25 of the supply device 2, or in an interior 26 of the supply device 2 that is surrounded by the housing 25, wherein the interior 26 is open toward the environment, or connected to the air space in the installation space R. Alternatively or additionally, the suction-side 23a is, for example, outside the housing 25 of the supply device 2, so as to be open toward the air space in the installation space R. For example, the gas flow generation installation 23 has an air flow generator.

The box-type housing 25 has lateral walls 25a, a rear wall 25b, a base 25c, an upper side 25d, and a pivotable door 25e. The upper side 25d is open toward the environment by means of an opened pivotable flap, as shown in FIGS. 1 and 2, so that sufficient ambient air always makes its way to the suction-side 23a of the gas flow generation installation 23 during the operation of the gas flow generation installation 23. Electrical cabling for supplying the supply device 2 with electric power is not illustrated, for example. The supply device 2 does not have a supply interface for a decentralized compressed air supply of the supply device 2, for example. Accordingly, the supply device 2 does not have any compressed air connection or compressed air input for supplying externally or centrally provided compressed air to the system 1, for example.

For example, the gas flow generation installation 23 comprises a gas compression unit for the gas flow generated at the suction-side in the line portion 21. The gas flow is able to be provided by air compressed and/or accelerated by the gas flow generation installation 23, which is possible in different ways. For example, the gas flow generation installation 23 has a compressed air compression unit. For example, the gas flow generation installation 23 operates according to the turbo-compressor principle with a radial compressor and/or axial compressor, for example, with a multi-stage radial compressor and/or with a multi-stage axial compressor.

A superordinate control unit 27, not illustrated in more detail, of the supply device 2 is computer controlled, or has software and a computer and storage unit, and serves to control the operation of the supply device 2. The control unit 27 serves, in particular, to control a definable or adaptable and/or adjustable output stage of the gas flow generation installation 23. For example, the compression of compressed air, the generation of compressed air and the air output able to be provided therewith are definable and/or variable by the control unit 27. The air output that is able to be provided is able to be adapted, in particular, to a real air demand, for example, a respective momentarily required air demand, for example, is able to be adapted dynamically, by the control unit 27. The real air demand is, in particular, programmable and/or, for example, dynamically adaptable to the real demand based on the sensor values detected by sensor mechanisms (not shown). Detected sensor values relate, for example, to a speed of the conveyed elements in the line portion 21 and/or the transport line 4. Based on the speed of the conveyed elements in the line portion 21 and/or the transport line 4 detected by sensors, it is possible to adapt the speed of the conveyed elements to a target value or nominal value stored in software, for example, by using the control unit 27.

The sensor mechanisms of the supply device 2 are provided for detecting and providing the sensor values, for example, for providing sensor values for the further processing by the control unit 27.

An alternative not illustrated of the system 1 is distinguished in that a supply device having the components according to the supply device 2 is present on the processing apparatus 3, for example, directly thereon, but without a housing 25, for example. Alternatively, a supply device having the functions, or having the components, according to the supply device 2 is present on the robot 9, for example. For example, a magazine for the elements with the storage container, and/or a sorting bin and/or a buffer line are additionally present on the robot 9. For example, exactly one supply device, or exactly two, or more than two, supply devices are provided for a system configured as a technology system. For example, it is also possible that at least one component according to the supply device 2 is present on the processing apparatus 3, and at least one other component according to the supply device 2 is present on the robot 9, in an alternative system.

In the case of an alternative system, or technology system, it is specified, for example, that the conveyance of the elements is provided on the processing apparatus 3 and/or on the robot 9, in order to convey the elements from a conveyor apparatus to a filling station of the processing apparatus.

In the case of an alternative system, or technology system, it is specified, for example, to convey the elements from a magazine, which for offering up a multiplicity of elements is provided on the processing apparatus, to a processing point of the processing apparatus. The processing point of the processing apparatus comprises, for example, a placing head of the processing unit, which comprises the ram unit and the die unit.

In a multi-track overall system having, for example, systems according to the system 1 operating in parallel, it is possible to specify, for example, that the respective track is conceived according to the system 1 described above.

A further alternative of a system is distinguished in that a normal compressor, or, for example, a commercially available known compressor, is present in the supply device 2 and/or on the processing apparatus 3 and/or on the robot 9. The compressor operates, for example, according to the displacement principle and is implemented as piston compressor or screw compressor, for example.

FIG. 4 shows a supply device 28 as an alternative to the supply device 2, without a housing part on the front side. The supply device 28 differs from the supply device 2 in terms of the gas flow generation installation 23. The gas flow generation installation 23 according to FIG. 4 is configured as a multi-stage radial fan 29. Air L from the environment is inducted at the suction-side of the gas flow generation installation 23, wherein a filter unit 30 is disposed upstream of the radial fan 29. Singularized elements are conveyed in the line portion 21 from an element transfer point 31 of a singularization installation 20 to the connection point 22 by a low-pressure gas flow, or air flow, between 1.03 and 1.5 bar.

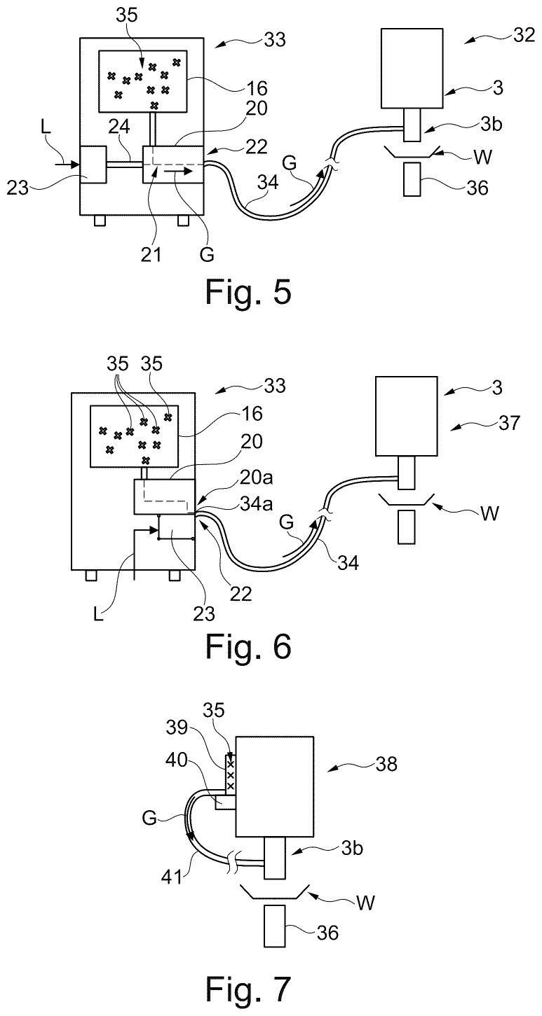

FIG. 5 very schematically shows a system 32 having a supply device 33 including a gas flow generation installation 23, a hollow transport line 34 through which elements 35 are able to be transported individually to a processing apparatus 3 of the system 32 by a low-pressure gas flow. An element 35 transported to the processing apparatus 3 is attached to a workpiece W by the processing apparatus 3, for example, pressed into the workpiece W with the aid of a movable power-driven ram of the processing apparatus 3. The workpiece W is supported on a die 36 of the processing apparatus 3, for example. A plurality of elements 35 are offered up, or stored, in a storage container 16 of the supply device 33.

The gas flow generation installation 23 is a single-stage or a multi-stage axial fan or radial fan, or a ventilator. An air flow, or a gas flow G, at a consistent absolute gas pressure between 1.03 and 1.50 is generated at the pressure-side of the gas flow generation installation 23.

The elements 35, which have been singularized in the singularization installation 20, are conveyed within the hollow transport line 34 to a placing head 3b having a ram unit of the processing apparatus 3 by the gas flow G provided by the gas flow generation installation 23. The gas flow G flows within the transport line 34 and is illustrated as a flow arrow outside the transport line 34 only for the purpose of improved illustration in FIG. 5 as well as in FIG. 6.

FIG. 6 shows an alternative system 37 having a supply device 33 including a gas flow generation installation 23, a hollow transport line 34 through which elements 35 are able to be transported individually to a processing apparatus 3 of the system 37 by a low-pressure gas flow provided by the gas flow generation installation 23.

A singularized element 35 is transferred into the transport line 34 by means of the singularization installation 20. A gas flow G in the direction toward the processing apparatus 3 is prevalent in the hollow transport line 34, as a result of which the elements 35 make their way in the transport line 34 to the processing apparatus 3. For example, one end 34a of the transport line 34 is moved in a reciprocating manner between a point 20a on the singularization installation 20 for receiving an individual element 35 into the transport line 34, and the connection point 22. The connection point 22 coincides, for example, with a pressure-side outlet of the gas flow generation installation 23. In this way, or in another way, an individual element 35 is in each case able to be moved into the transport line 34 and able to be transported onward to the processing apparatus 3. Absent from the system 37 is a line portion in the supply device 33, or a line portion 21 according to the assemblies described above is absent.

FIG. 7 shows a processing apparatus 38 which is an alternative to the processing apparatus 3 on which a workpiece W is positioned on a die 36. The processing apparatus 38 processes elements 35 of which a plurality are stored in a storage container 39, for example, a magazine, on the processing apparatus 38. The processing apparatus 38 comprises a gas flow generation installation 40 such as a fan or a ventilator. Gas or air from the environment of the processing apparatus 38 is able to be inducted by the gas flow generation installation 40, in order to provide a gas flow G, wherein a gas flow G at a low-pressure level with an absolute gas pressure between 1.03 bar and 1.50 bar is able to be provided on an outlet side of the gas flow generation installation 40. The elements 35 from the storage container 39 are able to be supplied individually to a placing head 3b of the processing apparatus 38 in a hollow transport line 41 by means of the gas flow G with a gas pressure between 1.03 bar and 1.5 bar.

### LIST OF REFERENCE SIGNS

1 System
2 Supply device
2a Roller
3 Processing apparatus
3a Line connection
3b Placing head
4 Transport line
4a, 4b End
5-8 Workpiece
9 Robot
10 Robotic arm
11 Machining station
12 C-bracket
13 Ram unit
14 Die unit
15 Drive
16 Storage container
16a Receiving capacity
17 Intermediate piece
18 Sorting bin
19 Buffer line
20 Singularization installation
20a Point
21 Line portion
22 Connection point
23 Gas flow generation installation
23a Suction-side
23b Pressure-side
24 Connecting line
25 Housing
25a Lateral wall
25b Rear wall
25c Base
25d Upper side
25e Door
26 Interior
27 Control unit
28 Supply device
29 Radial fan
30 Filter unit
31 Element transfer point
32 System
33 Supply device
34 Transport line
34a End
35 Element
36 Die
37 System
38 Processing apparatus
39 Storage container
40 Gas flow generation installation
41 Transport line

1. A supply device for elements, wherein the elements are able to be moved to a connection point of the supply device, wherein the supply device is designed as a separately positionable peripheral unit for supplying a processing apparatus with elements, wherein the elements are able to be ejected from the supply device by way of the connection point, and wherein the connection point is configured to connect to a hollow transport line that is connectable to the supply device in such a way that in the connected state of the transport line the elements are able to be transported in the hollow transport line from the connection point to the processing apparatus spaced apart from the supply device, wherein the elements are able to be transported by means of a gas flow, wherein the supply device has a gas flow generation installation which provides the gas flow in such a manner that, by virtue of the gas flow, the elements are able to be transported from the connection point by virtue of the gas flow provided by the gas flow generation installation, wherein the supply device is present in an installation space, wherein the gas flow generation installation is configured to induct air from the environment of the supply device in the installation space of the supply device in order to provide the gas flow, wherein the gas flow generation installation is configured to provide a gas flow at a low-pressure level with an absolute gas pressure between 1.03 bar and 1.50 bar at an outlet side of the gas flow generation installation.

2. The supply device as claimed in claim 1, wherein the gas flow generation installation comprises a fan or a ventilator.

3. The supply device as claimed in claim 1, wherein the supply device has a hollow line portion through which the elements are able to be moved from an element transfer point, at which the elements are able to be introduced into the line portion, to the connection point of the supply device.

4. The supply device as claimed in claim 1, wherein the elements which are able to be moved in the line portion, in the connected state of the line portion, the elements are able to be moved with the transport line from the element transfer point through the line portion to the connection point by virtue of the gas flow in the line portion.

5. The supply device as claimed in claim 1, wherein the gas flow generation installation comprises a gas compression unit for providing the gas flow.

6. The supply device as claimed in claim 1, wherein the gas flow generation installation comprises a gas compression unit according to the turbo-compressor principle for providing the gas flow.

7. The supply device as claimed in claim 1, wherein the gas flow generation installation comprises a gas compression unit for providing a gas flow generated at the pressure-side in the line portion.

8. The supply device as claimed in claim 1, wherein the gas flow generation installation comprises a gas compression unit for providing a gas flow generated at the suction-side in the line portion.

9. The supply device as claimed in claim 1, wherein the gas flow generation installation comprises a gas compression unit with a radial compressor for providing the gas flow, wherein the gas compression unit operates according to the turbo-compressor principle.

10. The supply device as claimed in claim 1, wherein the gas flow generation installation comprises a gas compression unit with an axial compressor for providing the gas flow, wherein the gas compression unit operates according to the turbo-compressor principle.

11. The supply device as claimed in claim 1, wherein the gas flow generation installation comprises a gas compression unit with a multi-stage compressor, wherein the gas compression unit operates according to the turbo-compressor principle.

12. The supply device as claimed in claim 1, further comprising a superordinate control unit for controlling an output stage of the gas flow generation installation.

13. The supply device as claimed in claim 1, further comprising sensor mechanisms for detecting and providing sensor values and for adapting a gas flow demand for providing the gas flow.

14. The supply device as claimed in claim 1, wherein the supply device is configured as a separate peripheral unit with a housing and an interior of the supply device that is surrounded by the housing.

15. The supply device as claimed in claim 1, wherein the supply device is configured to be adaptable in such a manner so as to offer up elements and to supply the latter from the supply device to the processing apparatus, wherein the elements are joining elements such as screws, rivets, punch rivets, functional elements such as stamping elements, punching elements, pressing elements, clinch-riveting elements, press-fit bolts and/or press-fit nuts.

16. The supply device as claimed in claim 1, wherein the supply device has a filter unit for filtering the gas, which serves to provide the gas flow.

17. A system having a processing apparatus for processing elements and a hollow transport line and a supply device as claimed in claim 1.

18. A processing apparatus for elements, comprising a gas flow generation installation by way of which air from the environment of the processing apparatus is able to be inducted in order to provide a gas flow for transporting elements, wherein providing at an outlet side of the gas flow generation installation a gas flow at a low-pressure level with an absolute gas pressure between 1.03 bar and 1.50 bar.
